(19) United States
(12) Patent Application Publication
(10) Pub. No.: US 2016/0085604 A1
(43) Pub. Date: Mar. 24, 2016

(54) DYNAMIC METHOD INVOCATION VIA PROXY FRAMEWORK

(71) Applicant: KARTHIKEYAN RAJAGOPALAN, BANGALORE KARNATAKA (IN)

(72) Inventor: KARTHIKEYAN RAJAGOPALAN, BANGALORE KARNATAKA (IN)

(73) Assignee: UNISYS CORPORATION, Blue Bell, PA (US)

(21) Appl. No.: 14/834,848

(22) Filed: Aug. 25, 2015

(30) Foreign Application Priority Data
Sep. 24, 2014 (IN) 2743/DEL/2014

(51) Int. Cl. G06F 9/54

(52) U.S. Cl. CPC G06F 9/547

(57) ABSTRACT

A solution for providing an infrastructure for a generated application created from a model-driven application development framework to invoke an external library is realized that is targeted for situations when an operating platform of the generated application is different than that of the external library. First, a proxy host receives a call from the generated application to invoke a method. An intermediate library is loaded, and the call is marshaled from the proxy host to the intermediate library. Finally, an external library is loaded by the intermediate library and invokes the method that the runtime wants to invoke.

### FIELD OF THE DISCLOSURE

The instant disclosure relates to application development. More specifically, this disclosure relates to invoking libraries in an application development framework.

### BACKGROUND

Model-driven application development frameworks have garnered increased attention as a platform for developing applications because of its ability to provide a generic environment for its users. Users who have zero or limited knowledge in application development are able to create applications for their devices that conform to the guidelines of a dynamic model. Model-drivel application development is adaptable and flexible, thus allowing users to focus on business development.

In model-driven application development framework, a data model is first created. From this data model, an application may be generated using an application development framework and information from the model. The framework may have provisions to specify an external library to be utilized by the generated application. The external library may contain programming routines and functions that assist in executing the application. This library may be from a third party vendor. Application programing interfaces (APIs) may be invoked by the generated application to access the library. In some frameworks, the architecture of the generated application and the external library may run on different targeted platforms. For example, the generated application could be running on a 64-bit Windows platform, while the external library is compiled on a 32-bit Windows platform. When this occurs, the application cannot load the library in the same process space, and a proxy host is required. The proxy host marshals all calls from the generated application to the external library. The proxy host may also enable loading of the external library in its own process space. The proxy hosting infrastructure may be provided by a third party vendor or developed by the user that generates the application.

In this approach, there is no reference in the data model to the external library and the hosting application. Every time the data model is modified to refer to a new external library or the library itself is modified, a modification in the target builder (a part of the data model and the application development framework that creates code to generate the application) is required. Thus, there is a need to provide a solution that removes the necessity to make changes in the target builder when referencing new external libraries or existing libraries that have been modified.

### SUMMARY

A generic hosting utility may be used to provide an infrastructure for accessing an external library, which may or may not be built on the same platform architecture as an application accessing the library. The generic hosting utility may marshal all application calls to the external library. Use of the generic hosting utility may reduce or eliminate effort required from either the third party vendor (who provides the external library) the application developer (who develops the application from the model) in establishing the hosting process to complete the system. The proposed scheme described in further detail below may remove the dependency between the data model used to generate an application and the external library.

In one embodiment, an intermediate library may be used in the generic hosting utility. If the data model has reference to an external library that is targeted to a different platform architecture than that of the generated application, the application development framework may generate an intermediate library. A proxy host may utilize this intermediate library to communicate between the proxy host and the external library. The intermediate library may contain a plurality of interface methods. The proxy host may include information on how a particular method can be invoked along with path information related to the intermediate library. When a 64-bit runtime application invokes a method in a 32-bit external library, the application may initiate an out-of-process call to a 32-bit proxy host and pass information about the intermediate library and the method being invoked. The 32-bit proxy host may load the intermediate library and pass information about the method that the runtime is invoking. Finally, the intermediate library may load the external library and invoke the called method. In one embodiment, the generic hosting utility with intermediate library may be implemented in the Unisys Agile Business Suite Common Language runtime.

According to one embodiment, a method may include receiving a call to access an external library of a plurality of external libraries to invoke at least one method of a plurality of methods from an application created from a data model; loading an intermediate library to communicate with the external library; and marshaling, to the intermediate library, the call of the at least one method of the plurality of methods to be invoked by the external library.

According to another embodiment, a method may include receiving a call from a proxy host to invoke at least one method of a plurality of methods requested by an application created from a data model; receiving the at least one method of the plurality of methods to be invoked by an external library of a plurality of external libraries; loading the external library to invoke the at least one method of the plurality of methods; and marshaling, to the external library, the call and a signature of the at least one method of the plurality of methods to be invoked by the external library.

According to a further embodiment, an apparatus may include a processor and a memory coupled to the processor. The processor may be configured to perform the steps of receiving a call to access an external library of a plurality of external libraries to invoke at least one method of a plurality of methods from an application created from a data model; loading an intermediate library to communicate with the external library; and marshaling, to the intermediate library, the call of the at least one method of the plurality of methods to be invoked by the external library.

According to yet another embodiment, an apparatus may include a processor and a memory coupled to the processor. The processor may be configured to perform the steps of receiving a call from a proxy host to invoke at least one method of a plurality of methods requested by an application created from a data model; receiving the at least one method of the plurality of methods to be invoked by an external library of a plurality of external libraries; loading the external library to invoke the at least one method of the plurality of methods; and marshaling, to the external library, the call and a signature of the at least one method of the plurality of methods to be invoked by the external library.

As used herein, “marshaling” may refer to a mechanism by which data can be transferred between two different processes.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a limitation of the present invention.

### BRIEF DESCRIPTION OF THE DRAWINGS

For a more complete understanding of the disclosed system and methods, reference is now made to the following descriptions taken in conjunction with the accompanying drawings.

FIG. 1 illustrates an overview of an application development framework according to one embodiment.

FIG. 2 illustrates an overview of a proxy host process interfacing with a generated application according to one embodiment.

FIG. 3 is a flow chart illustrating the process of invoking a method from a proxy host according to one embodiment.

FIG. 4 is a flow chart illustrating the process of invoking a method by from an intermediate library according to one embodiment.

FIG. 5 is pseudo code that could be implemented on a computing device illustrating an example of how the generated application, proxy host and, intermediate library participate in invoking a method according to one embodiment.

FIG. 6 is a flow chart illustrating the process of how to invoke a method depending on the platform of the application and the external library according to one embodiment.

FIG. 7 illustrates one embodiment of a system for an information system, including a system for generating an application and invoking a method according to one embodiment.

FIG. 8 illustrates a computer system adapted according to certain embodiments of the server and/or the user interface device.

### DETAILED DESCRIPTION

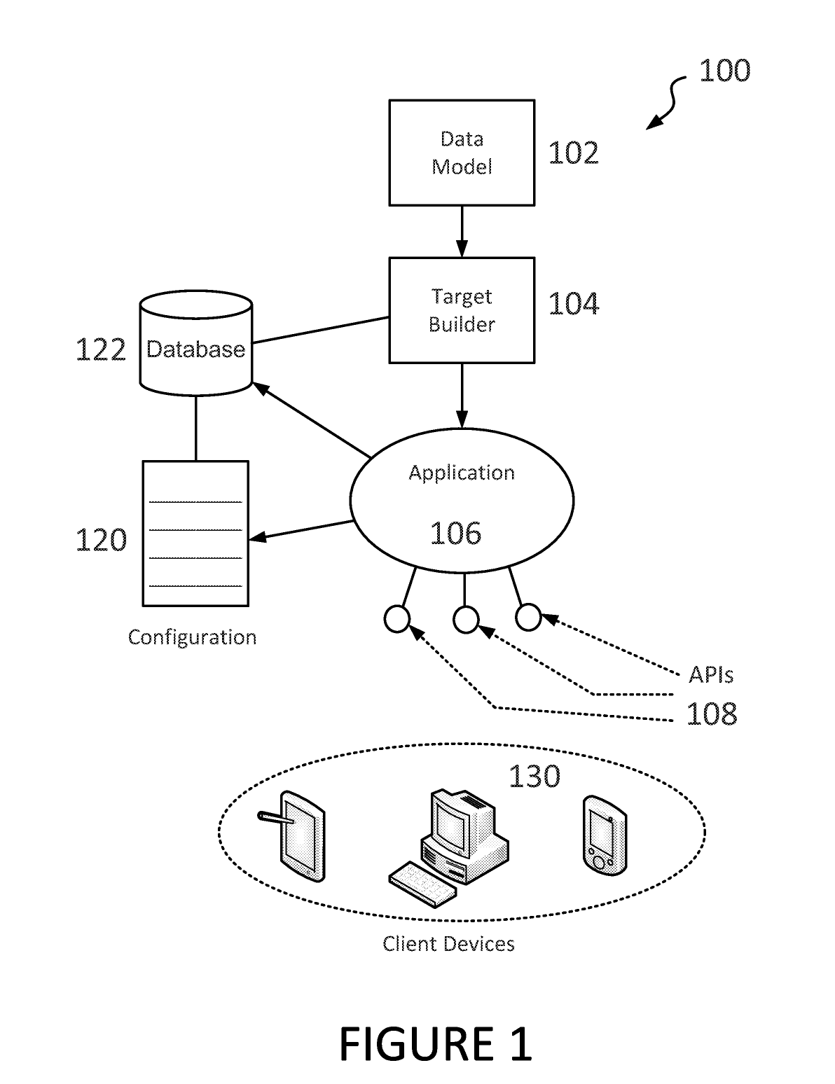

FIG. 1 illustrates an overview of an application development framework according to one embodiment. One of the building blocks of application development framework 100 is the development of a data model 102. Data model 102 may model large enterprise class applications as a set of classes to represent logical entities in an actual application. Model 102 may include data related to behavior, relationships, cost, etc. In addition, there are several ways to define the runtime behavior of a class, such as by adding logic to the class, setting class properties, and/or defining relationships between the classes in the model. A target builder 104 may create computer code based on information from the data model 102. Computer code may be created in a 3^{rd} party generation language such as, C, C++, C sharp (C#), Java, BASIC, PASCAL, or other languages.

Once this code is compiled, an application 106 may be generated. In a Windows platform, application 106 may comprise, for example, a COM+ application written in C#. Applications 106 may be generated on any computing platform, such as the Android platform, Macintosh (MAC) platform, Linux platform, another mobile platform, a cloud computing platform, or the like. The generated application 106 may expose a set of APIs 108 that may be utilized by one or more client devices 130 to develop web applications and obtain information for executing programs. The client devices 130 may include, for example, tablet personal computers, mobile phones, laptops, desktops, workstations, other handheld terminal, or any device that allows a user to computationally process information or data.

After the application 106 has been generated, a configuration file 120 may be created. The configuration file may include, for example, a system name, platform properties, and/or a unique identifier that corresponds to the application. The configuration file may comprise an extensible markup language (XML) file, a YAML file, and/or a CONFIG.SYS file. In one embodiment, a newly generated application 106 may include a newly generated. configuration file. In another embodiment, if an existing application 106 (having an existing configuration file) is regenerated with only a small modification to the application 106, the application 106 may be vetted for changes and the existing configuration file may be modified accordingly.

The database 122 may be utilized by the target builder 104 and/or the generated application 106, and/or referenced by the configuration file 120. In one embodiment, the target builder 104 may store a copy of the code created for the application 106 in the database 122. Additionally, the target builder 104 may obtain information from database 122 to use for generating the application 106. In another embodiment, a copy of the generated application 106 may be stored in the database 122 as a backup application. The backup application may be recalled in case the original application 106 is unusable or if a user intentionally modifies the application 106 for testing purposes. In another embodiment, the configuration file 120 may be stored in the database 122. The database 122 may be a part of an operating system or external to the operating system, but may be utilized by the operating system when needed.

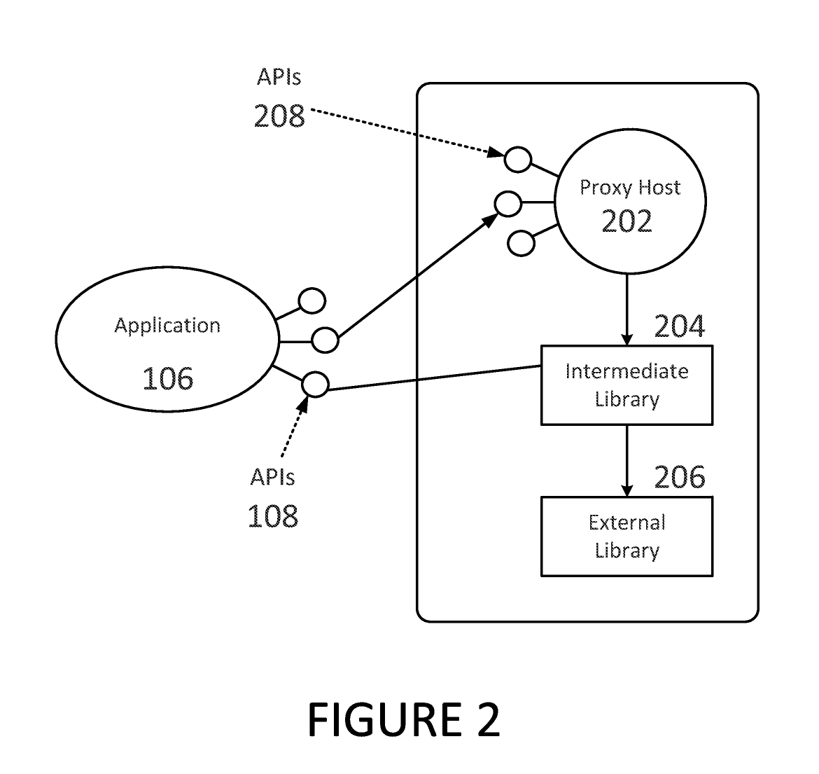

The application 106 may access external libraries not generated by the target builder 104. These external libraries may be accessed through a proxy host. FIG. 2 illustrates an overview of a proxy host process interfacing with a generated application according to one embodiment. When a generated application 106 accesses an external library 206, a proxy host 202 process may be employed. The external library 206 may be hosted by the proxy host 202. The proxy host 202 may marshal some or all calls from the generated application 106 to the external library 206. The external library 206 may be supplied by a third party vendor or may be developed by the target builder in the generating the application. In one embodiment, marshaling may refer to a method by which data may be transferred between two different processes.

An API 208 of the proxy host 202 may expose the methods of the external library 206. If the data model 102 of FIG. 1 references an external library 206 that is targeted to a different platform than that of the generated application 106, a compiler (not shown) for the data model 102 may create an intermediate library 204. The intermediate library 204 may be hosted by the proxy host 202 and serves as a liaison between the proxy host 202 and the external library 206. The intermediate library 204 may load the external library 206 and may invoke the method referenced by the data model 1-2.

In one embodiment, the intermediate library 204 may contain specific methods upon which the generated application 106 may communicate calls to the external library 206. Some of these methods may include generic methods as well as signature methods in which a signature corresponds to the signature of the external library 206. A generic method may be implemented in any intermediate library and given a generic name, such as “InvokeMethod( . . . ),” while signature methods may possess a unique method name that is shared with other methods in the external library, such as, ReadData(string filename), where “filename” is the same for all methods. In another embodiment, the intermediate library 204 may communicate directly with the APIs 108 of the generated application 106 to receive information about a method invoked by the generated application 106. In yet another embodiment, each intermediate library 204 may marshal calls to a corresponding external library 206. In a further embodiment, the intermediate library 204 may be created by a compiler, contain information about a method invoked by the generated application 106, and marshal calls to any external library 206 based on a preference of the proxy host 202. Some preferences that may be set in the proxy host 202 may include configuring any intermediate library to be accessed by an external library based on the configuration of that external library.

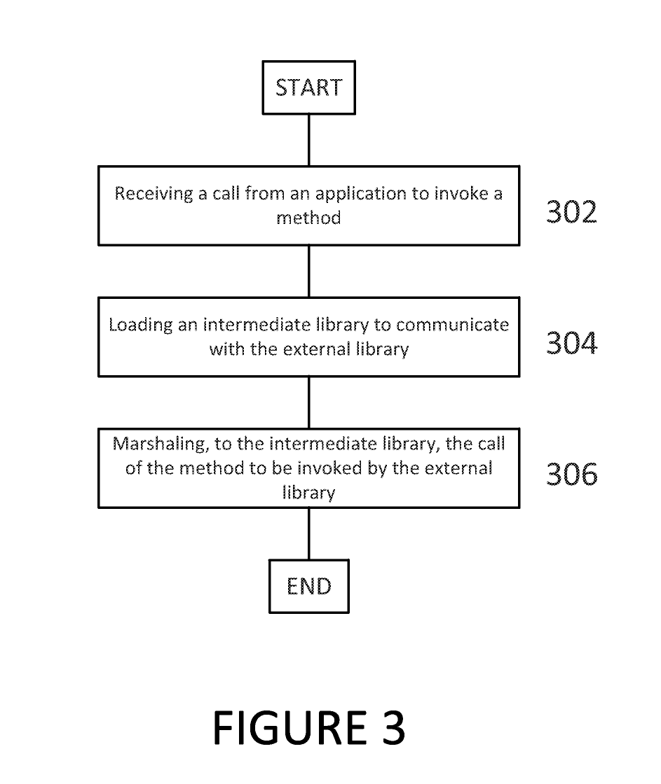

FIG. 3 is a flow chart illustrating the process of invoking a method from a proxy host according to one embodiment. The method starts at step 302 where a proxy host 202 receives a call from a generated application 106 to invoke a method in the external library 206. The calls that are received may include remote procedure calls (RPCs). The proxy host 202 may contain information about the method invoked at step 302. In one embodiment, certain parameters may be transferred in the call to the proxy host 202, such as the name of the method in the external library 206, the input parameters of the method, an operating platform of the method, and/or the return data type.

At step 304, the proxy host 202 loads the intermediate library 204 to communicate with the external library 206 to invoke the method. This may be based on information the proxy host 202 may possess about the data path of the intermediate library 204. Finally, at step 306, the proxy host 202 marshals the call of the method to be invoked by the external library 206 to the intermediate library 204. The intermediate library 204 may contain information about the signature of the method to be invoked from the external library 206.

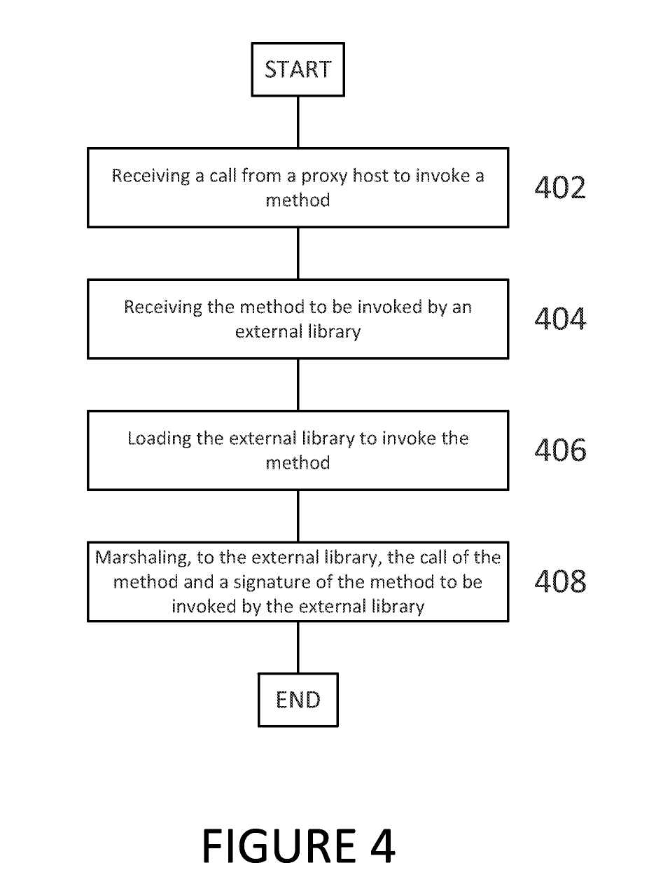

FIG. 4 is a flow chart illustrating the process of invoking a method by from an intermediate library according to one embodiment. The method starts at step 402 where a call is received from a proxy host 202 to invoke a method. The calls that are received may include remote procedure calls (RPCs). At step 404, the intermediate library receives the method to be invoked by the external library 206. The intermediate library 204 may contain information on how to marshal calls to the external library 206.

At step 406, the external library 206 is loaded by the intermediate library 204. The loading process may be performed with logic maintained by the intermediate library 204. Finally, at step 408, the intermediate library 204 transmits, to the external library 206, the method and the signature of the method to be invoked by the external library 206. The intermediate library 204 may allow the generated application 106 (operating on one platform, for example, a 64-bit Windows platform) to utilize external libraries (operable for a platform different than the generated application, for example, a 32-bit Windows platform) without the need for the target builder to modify or regenerate code to compensate for this difference.

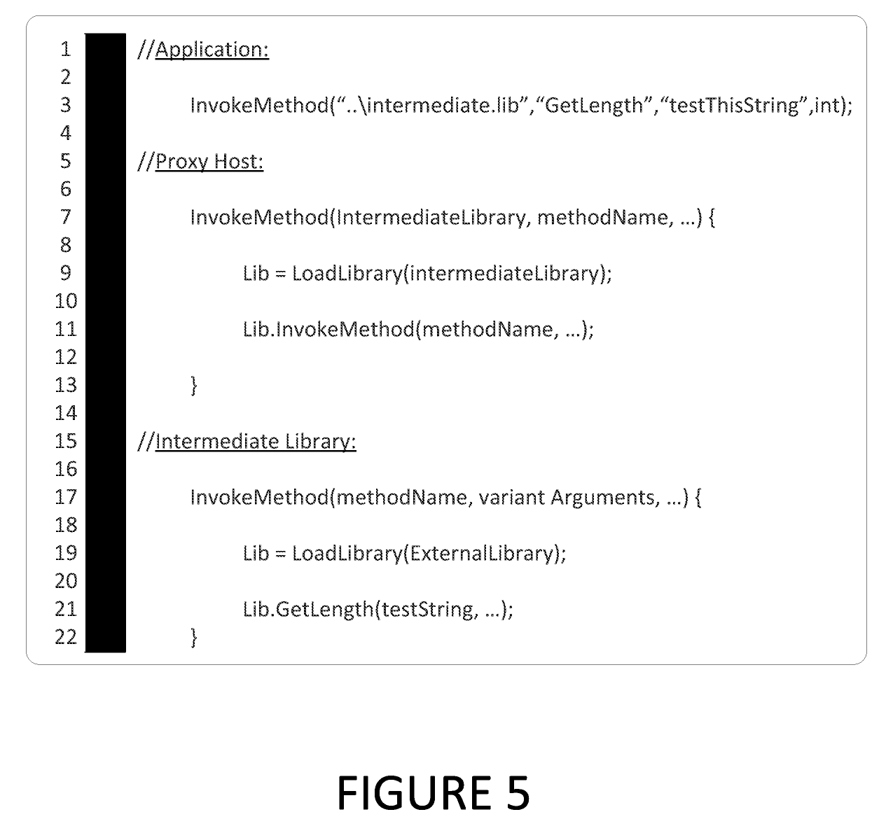

FIG. 5 is pseudo code that could be implemented on a computing device illustrating an example of how the generated application, proxy host and, intermediate library participate in invoking a method according to one embodiment. Lines 1, 5, and 15 may comprise comment lines that are used as titles for the application, proxy host, and the intermediate library, respectively. Line 3 may direct the generated application 106 to call a function called “InvokeMethod” to invoke a desired method. This function call may pass arguments, such as static libraries, integers variables, string commands, and/or the like.

When the function “InvokeMethod” is called by the application 106, the proxy host 202 executes the function at line 7. The proxy host may expose a generic interface method, which may accept the following parameters: name of the external library, the input parameters of the method, the return type and/or the path of the intermediate library. In line 9, a function named “LoadLibrary” may be called and assigned to the variable “Lib.” This function may load the intermediate library 204. In line 11, the proxy host 202 may call a function entitled “Lib.InvokeMethod” that invokes the method and receives the method name as one of the arguments.

In line 17, the intermediate library 204 may perform the “InvokeMethod” function with the method name and other parameters passed to the function as arguments. in line 19, the “LoadLibrary” function may be called and assigned to the variable “Lib.” This function may load the external library 206. Finally, in line 21, a function “Lib.GetLength” may be called and an argument passed to the function. This pseudo code illustrates one manner in which these processes may be implemented. This pseudo code is not intended to be limiting as there are several ways in which code can be written to carry out the functions of the application 106, proxy host 202, and intermediate library 204.

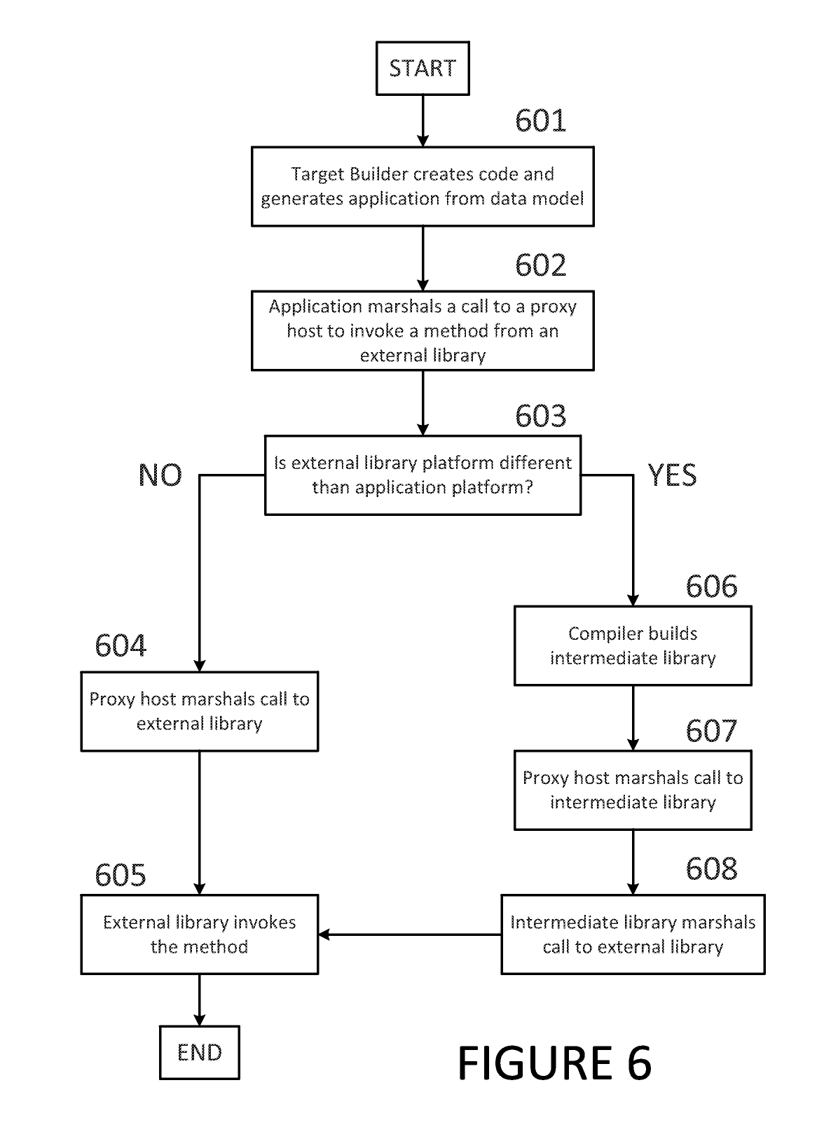

FIG. 6 is a flow chart illustrating the process of invoking a method depending on the platform of the application and the external library according to one embodiment. The process starts at step 601 with the target builder 104 creating code to generate an application 106 using the data model 102. At step 602, the generated application 106 marshals a call to a proxy host 202 to invoke a method from an external library 206. The proxy host 202 may maintain information about the external library 206 and the generated application 106 such as the platform that each process uses to operate. At step 603, the platforms of the external library 206 and the application 106 are compared. If the platforms for the external library 206 and application 106 are the same, the proxy host 202 marshals the call to external library 206 at step 604. Finally, the external library 206 invokes the method at step 605 and the process terminates or executes other commands.

At step 603, if the platforms for the external library 206 and the application 106 are different, the compiler (a part of the application development framework) constructs an intermediate library 204 at step 606. At step 607, the proxy host 202 marshals the call to the intermediate library 204, and may also collect information regarding the method to be invoked. At step 608, the intermediate library 204 marshals the call to the external library 206. The intermediate library 204 may maintain information about the signature of the invoked method. Finally, the external library 206 invokes the method at step 605 and the process terminates.

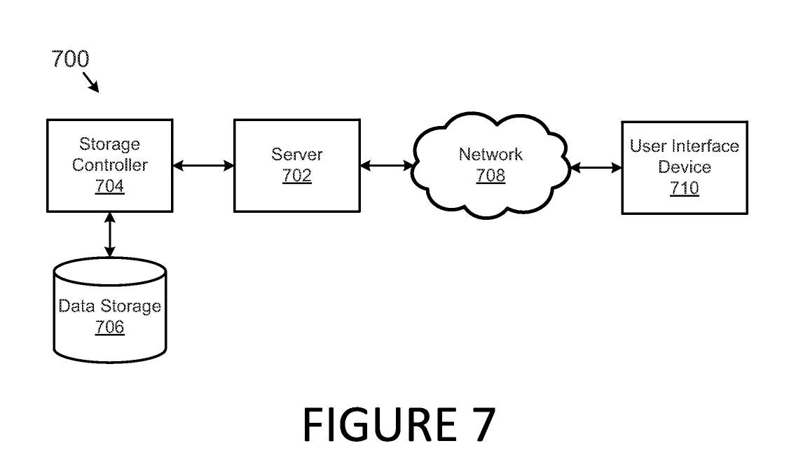

FIG. 7 illustrates one embodiment of a system 700 for an information system, including a system for generating an application and invoking a method through a proxy host according to one embodiment. The system 700 may include a server 702, a data storage device 706, a network 708, and a user interface device 710. In a further embodiment, the system 700 may include a storage controller 704, or storage server configured to manage data communications between the data storage device 706 and the server 702 or other components in communication with the network 708. In an alternative embodiment, the storage controller 704 may be coupled to the network 708. The system 700 may support code analysis by hosting the database 122 of FIG. 1 on the server 702.

In one embodiment, the user interface device 710 is referred to broadly and is intended to encompass a suitable processor-based device such as a desktop computer, a laptop computer, a personal digital assistant (PDA) or tablet computer, a smartphone, or other mobile communication device having access to the network 708. In a further embodiment, the user interface device 710 may access the Internet or other wide area or local area network to access a web application or web service hosted by the server 702 and may provide a user interface for communicating with the proxy host 202 of FIG. 2.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

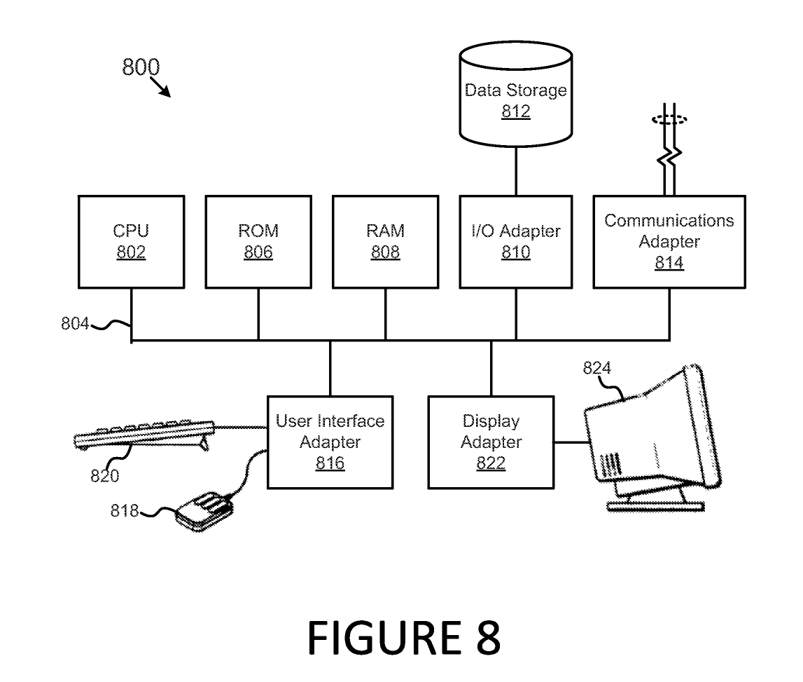

FIG. 8 illustrates a computer system 800 adapted according to certain embodiments of the server 702 and/or the user interface device 710. The central processing unit (“CPU”) 802 is coupled to the system bus 804. Although only a single CPU is shown, multiple CPUs may be present. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 may also include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The keyboard 820 may be an on-screen keyboard displayed on a touch panel. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of the server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASICs), very large scale integrated (VLSI) circuits, or other circuitry. In fact, persons of ordinary skill in the art may utilize any number of suitable structures capable of executing logical operations according to the described embodiments. For example, the computer system may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a call from an application to access a library external to the application to execute at least one method of an application;
loading an intermediate library having access to the external library;
transmitting, to the intermediate library, the call of the at least one method to be invoked in the external library; and
receiving a return value from the at least one method after execution by an external library.

2. The method of claim 1, wherein the intermediate library comprises a plurality of methods that the application may call to execute methods in the external library.

3. The method of claim 1, further comprising communicating, through the intermediate library, with at least one application programming interface (API) of the application to receive information about at least one method of the application.

4. The method of claim 3, wherein the step of communicating to receive information comprises receiving at least one of an input parameter of the method, an operating platform of the method, and a return data type.

5. The method of claim 1, wherein the at least one method comprises at least one of a generic method and a signature method, wherein a signature of the signature method corresponds to a signature of the library.

6. The method of claim 1, further comprising the step of exposing at least one method that the external library can invoke through an application programming interface (API) of a proxy host.

7. The method of claim 1, wherein the step of loading an intermediate library is based, at least in part, on information about a data path of the intermediate library.

8. A computer program product, comprising:
a non-transitory computer readable medium comprising instructions which, when executed by a processor of a computing system, cause the processor to perform the steps of:
receiving a call from an application to access a library external to the application to execute at least one method of an application;
loading an intermediate library having access to the external library;
transmitting, to the intermediate library, the call of the at least one method to be invoked in the external library; and
receiving a return value from the at least one method after execution by an external library.

9. The method of claim 8, wherein the intermediate library comprises a plurality of methods that the application may call to execute methods in the external library.

10. The method of claim 8, wherein the medium further comprises instructions to perform the step of communicating, through the intermediate library, with at least one application programming interface (API) of the application to receive information about at least one method of the application.

11. The method of claim 10, wherein the step of communicating to receive information comprises receiving at least one of an input parameter of the method, an operating platform of the method, and a return data type.

12. The method of claim 8, wherein the at least one method comprises at least one of a generic method and a signature method, wherein a signature of the signature method corresponds to a signature of the library.

13. The method of claim 8, wherein the medium further comprises instructions to perform the step of exposing at least one method that the external library can invoke through an application programming interface (API) of a proxy host.

14. The method of claim 8, wherein the step of loading an intermediate library is based, at least in part, on information about a data path of the intermediate library.

15. An apparatus, comprising:
a memory; and
a processor coupled to the memory, wherein the processor is configured to perform the steps of:
receiving a call from an application to access a library external to the application to execute at least one method of an application;
loading an intermediate library having access to the external library;
transmitting, to the intermediate library, the call of the at least one method to be invoked in the external library; and
receiving a return value from the at least one method after execution by an external library.

16. The apparatus of claim 15, wherein the intermediate library comprises a plurality of methods that the application may call to execute methods in the external library.

17. The apparatus of claim 15, wherein the processor is further configured to perform the step of communicating, through the intermediate library, with at least one application programming interface (API) of the application to receive information about at least one method of the application.

18. The apparatus of claim 17, wherein the step of communicating to receive information comprises receiving at least one of an input parameter of the method, an operating platform of the method, and a return data type.

19. The apparatus of claim 15, wherein the at least one method comprises at least one of a generic method and a signature method, wherein a signature of the signature method corresponds to a signature of the library.

20. The apparatus of claim 15, wherein the processor is further configured to perform the step of exposing at least one method that the external library can invoke through an application programming interface (API) of a proxy host.
